(19) United States
(12) Patent Application Publication
(10) Pub. No.: US 2011/0146588 A1
(43) Pub. Date: Jun. 23, 2011

(54) Rising Sun Twilight Scent Training System

(76) Inventor: Jesse Harlan Ward, Cheyenne, WY (US)

(21) Appl. No.: 12/577,732

(22) Filed: Dec. 18, 2009

(51) Int. Cl. A01K 15/02

(52) U.S. Cl. 119/712; 119/720

(57) ABSTRACT

The invention will revolutionize dog/animal training by providing a scent based language. It works by utilizing programmable variations of scent and labeling them with teaching commands. The handler gives a teaching command by pressing a button on the (Twilight) remote. The (Rising Sun) headset/harness picks up the signal through a receiver and then delivers the designated scent and voice command.

### BACKGROUND OF THE INVENTION

This invention will represent the outcome of many years as a dog/animal trainer. I have followed the teachings of a wolf that I had successfully raised/trained as well as the teachings of Caesar Millan. My website (www.wardfamilygsds.com) is proof of my capabilities as a teacher/trainer.

The aspect of connecting a scent to a given command came about while trying to surpass one hundred plus commands with my current German Shepherd dogs. With scent variables linked to the given commands it makes the number of commands to be used limitless.

The invention will revolutionize dog/animal training by providing a scent based language. It works by utilizing programmable variations of scent and labeling them with teaching commands. The significance of using scent for training is clear when you look at how the olfactory part of the dogs brain dominates over other senses for processing information about their environment.

The human brain is dominated by a large visual cortex, while the dog brain is dominated by an olfactory cortex. According to Wikipedia and associated links, the olfactory bulb in dogs is around forty times bigger than the olfactory bulb in humans, relative to total brain size, with 125 to 220 million smell-sensitive receptors. Dogs discriminate odors at concentrations nearly 100 million times lower than humans can. A dog's brain is specialized for identifying scents. The percentage of the dog's brain devoted to analyzing smells is actually 40 times larger than that of a human! It has been estimated that dogs can identify smells somewhere between 1,000 to 10,000 times better than nasally challenged humans can.

### SUMMARY OF INVENTION

The invention will revolutionize dog/animal training by providing a scent based language. It works by utilizing programmable variations of scent and labeling them with teaching commands. The handler gives a teaching command by pressing a button on the (Twilight) remote.

The (Rising Sun) headset/harness picks up the signal through a receiver, while at the same time delivering the designated scent and voice command. When the scent is delivered a voice command is given through the head set speaker. The scent is delivered to the dogs nostrils through a small burst generated by the pump. The Binary decoder correlates the scent mixture with the signal given by the (twilight) remote.

The Headset is ran by batteries that are charged by the motion activated battery charger attached to the shoulder strap of the harness. The headset also has an option for a flashlight/camcorder activated by push button or by the (Twilight) remote. Thus expanding the training capabilities exponentially, breaking ground never before reached, and providing limitless possibilities.

This invention would allow dogs and other animals to excel in ways never before imagined. It could be used in any aspect of training with older dogs/animals and puppies/baby animals as well. This invention is to be utilized per the training guidelines set forth in the owner manual accompanying it. The (Rising Sun) headset/harness are all one unit, designed for efficiency in the field or at home. The (Twilight) remote is designed for easy use with an easy punch number pad, glowing screen, camera, speaker, recorder, GPS, satellite connection and a motion activated battery charger. The (Twilight) remote connects to the magnetic or Velcro strip on the harness for easy storage.

### BRIEF DESCRIPTION OF THE DRAWINGS

FIG. 1: Rising Sun Harness

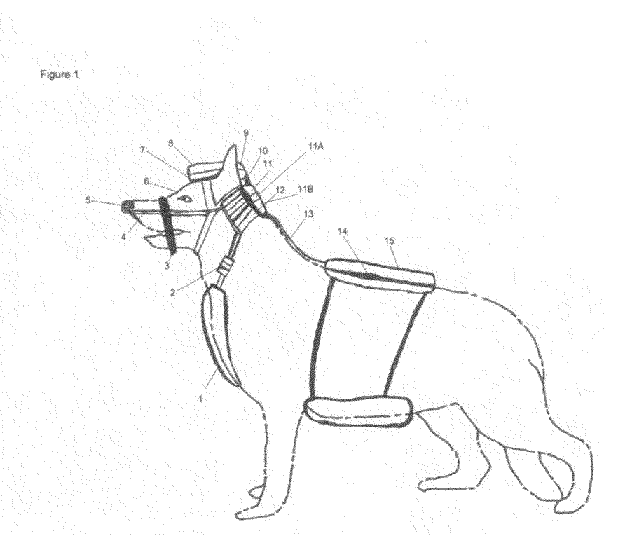

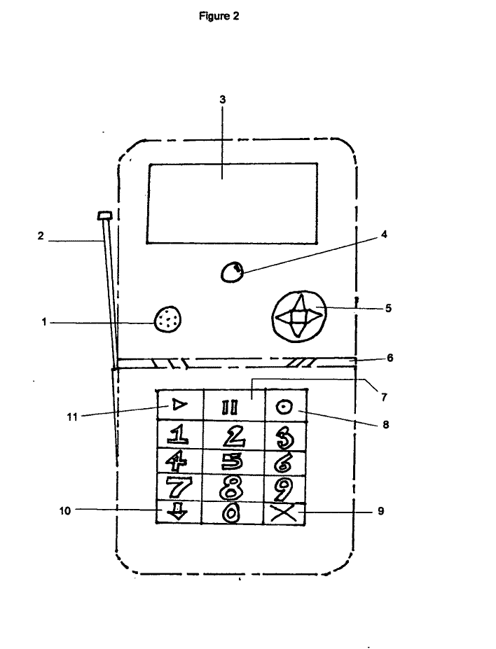

1. Spandex Material to hold the different components together and provide flexibility.

2. Motion activated battery charger to recharge the batteries in the pump and the decoder.

3. Nostril strap will hold the scent tubing in place.

4. Tubing that connects the scent mixer to the one way vent and allows for the scent to be delivered to the dogs' nostrils.

5. One way vent delivers scent and prevents foreign scent and material from disrupting the scent delivery system.

6. Muzzle strap (center) connects the nostril strap holding and stabilizing the headset in place.

7. Camera/Camcorder/speaker to help record or document valuable field data for home land security or police K9's

8. Flashlight for sight at a distance at night and for night recognizance.

9. Decoder (binary) receives signals from the cell phone receiver and delivers the designated signal to the scent mixer.

10. Wires connect the decoder to the scent delivery system.

11. Pump delivers the scent to the one way vented nose piece.

11.a. Scent mixer works from the pumps operating to provide the exact timed scent or scent mixture for delivery to the nose piece.

11.b. Cell phone/GPS receiver receives the signal from the Twilight remote and sends the signal to the Decoder.

12. Scent vials provide the scent to be delivered to the one way vented nose piece.

13. Harness is for stability and flexibility of the headset and neck piece.

14. Magnetic Velcro Strip provides a spot to put the Twilight remote for easy storage.

15. Velcro sides allows for people to put labeled signs or other information on their dog/animal.

FIG. 2: Twilight Remote

1. Speaker is for recording voice commands and hearing the designated verbal command.

2. Satellite receiver for conveying the information to the cell phone/GPS receiver.

3. Screen is where information is conveyed to the handler.

4. Camera button allows the handler to take a photograph of what the camcorder on the headset sees.

5. Directional key pad allows the handler the capabilities to navigate a GPS related map, and operate the programmable training codes portrayed on the screen.

6. Hinge is the connecting joint of the upper and lower pieces.

7. Pause button allows for the opportunity to stop the dog in the middle of a series of commands to make corrections and then continue.

8. Power button is the on/off switch allowing for full operation of the Twilight remote.

9. Correction button allowing for a scent burst of citronella as a form of correction.

10. Saving or recording button allows the handler to save routines or record and save their voice to given commands.

11. Play or send button allows the handler the option of playing a series of commands or sending one command at a time to a dog/animal.

1. To utilize a new form of teaching/training brought forth by this invention (scent based language). It will give rise to a consciousness never before reached for dogs and other animals where scent is their dominate sense. The goal is to improve comprehension and performance for dogs/animals and their handlers.

2. Instead of training for one area of expertise such as hunting in the case of dogs, this invention and its training program will allow for a dog to go far beyond one area of expertise on levels never before seen. For already trained/partially trained or older dogs/animals you would mark the commands already known to a variation of scent. Then you'll eventually take the verbal and hand commands out of the training connecting only through scent to fulfill the command.

3. The (Rising Sun) Headset/harness is a tool, that when controlled properly by the (Twilight) remote, will efficiently label smells to the commands using the animals most dominant sense. In the case of blind or def animals it will tap into the other strongest sense available for communication.
